(19) United States
(12) Patent Application Publication
(10) Pub. No.: US 2026/0058531 A1
(43) Pub. Date: Feb. 26, 2026

(54) Method for Producing Sheets for Sheet Packages of a Rotor and/or Stator for Three-Phase Drives, in Particular for Reluctance Machines (Reluctance Motors)

(71) Applicant: Dr.-Ing. Siegfried Haussmann Industrieelektronik, Nürtingen (DE)

(72) Inventors: Karl-Heinz Wurst, Stuttgart-Vaihingen (DE); Alexander Verl, Ludwigsburg (DE); Siegfried Haussmann, Nürtingen (DE)

(73) Assignee: Dr.-Ing. Siegfried Haußmann Industrieelektronik, Nürtingen (DE)

(21) Appl. No.: 19/307,549

(22) Filed: Aug. 22, 2025

(30) Foreign Application Priority Data
Aug. 24, 2024 (DE) 10 2024 002 802.1

(51) Int. Cl. H02K 15/022; B22D 23/00; B22D 39/00; B33Y 10/00; B33Y 80/00; H02K 15/038; H02K 15/121

(52) U.S. Cl. CPC H02K 15/022; B22D 23/003; B22D 39/003; B33Y 10/00; B33Y 80/00; H02K 15/038; H02K 15/121

(57) ABSTRACT

A method is used for producing metal sheets for packets of metal sheets of a rotor and of a stator for three-phase drives, in particular for reluctance machines (reluctance motors) made of magnetic, in particular magnetically soft materials by means of additive production processes, in which the magnetizable material is melted and fed to at least one print head which applies the melted material to form a rotor/stator sheet. The melted material is influenced by an applied magnetic field so that the finished rotor/stator sheet has an area with high magnetic conductivity determining the desired direction of flow.

### CROSS-REFERENCE TO RELATED APPLICATION

This application claims the benefit of German Patent Application No. 10 2024 002 802.1, filed on 24 Aug. 2024, the content of which is hereby incorporated by reference in its entirety.

### TECHNICAL FIELD

The disclosure relates to a method for producing metal sheets for packages of metal sheets of a rotor and/or stator for three-phase drives, in particular for reluctance machines (reluctance motors).

### BACKGROUND

The demand for electric drives in automation technology and automotive engineering is constantly increasing (due to changes in energy technology). Demand for inexpensive yet highly efficient electric drives is increasing, particularly in the field of electromobility.

The demand for highly efficient drives is currently being met primarily by the provision of permanent magnet synchronous machines which generate torque via rotor-side magnets made of rare earth materials. Such drives generally offer significant potential for performance enhancement, but the high costs of permanent magnet synchronous machines using rare earth materials are a disadvantage for their widespread use. The environmental risks associated with the extraction of rare earth metals should not be ignored.

In contrast, reluctance motors represent an inexpensive type of drive. In its basic version, the reluctance motor (often used as a synchronous reluctance motor in automation and automotive technology) has a robust and inexpensive rotor without magnets or rotor windings. This results in low manufacturing costs due to the technically simple structure and comparatively inexpensive materials for the rotor. A disadvantage is its currently low power factor.

### SUMMARY

Different types of reluctance motors are known: switched reluctance motors (SRM) (FIG. 1) and synchronous reluctance motors (SynRM) (FIG. 2). Switched reluctance motors have concentrated windings and are comparable to stepper motors (reluctance stepper motors) in terms of their operation and mechanical structure, while synchronous reluctance motors have distributed windings which generate a continuously rotating stator field which the magnetically anisotropic rotor follows.

The standard electromagnetic stepper motor (switched reluctance motor) (FIG. 1) can be imagined as the integration of several individual electromagnets, where the mechanical and electrical state changes are generated by pulsed excitation currents. FIG. 1a shows an example of a 4-pole embodiment. Higher-pole embodiments can also be used.

The excitation windings 105 are incorporated into the toothed structure of the stator 104. Each stator tooth is formed by a coil. The rotor 103 has neither a winding nor a permanent magnet (an inexpensive rotor). This means that no currents are induced in the rotor; only magnetic forces act.

Applying a voltage to a winding 105 in the stator causes a current to flow. This generates a magnetic flow 101, which flows through the stator 104 and the rotor 103. The rotor 103 rotates in the direction in which the magnetic resistance for the magnetic flow decreases.

The simplest rotor 103 consists of a toothed, solid piece of soft iron with a cross-section like 102. This condition causes relatively high eddy currents in the rotor 103 (heat generation), which is why rotors 103 primarily consist of soft iron packets made of stacked metal sheets 102. The example geometry of a single metal sheet 102 is shown in FIG. 1b.

FIG. 2 shows a detail of an example of a synchronous reluctance motor. In a synchronous reluctance motor, a rotating magnetic field is generated by the stator winding 205 in the stator sheet 206—as in other rotating-field motors. The rotor 204, however, consists of a round packet of metal sheets from which magnetic flow barriers 201 are typically punched. The magnetic flow 203 is guided using the flow webs (magnetic paths) 202.

The courses of the flow barriers 201 and the flow webs 202 in the laminated rotor 204 determine the magnetic flow and thus also the properties of the motor.

The function-oriented structure of reluctance motors outlined in FIG. 2 takes place therein using the example of what is referred to as an internal rotor, as is primarily used on the market, i.e. the moving rotor is located inside.

FIG. 2a shows, by way of example, how the flow webs 202 guide the magnetic flow 203 along the d-axis of the rotor, and FIG. 2b shows how the flow barriers 201 block the magnetic flow 203 along the q-axis of the rotor 204, thereby resulting in the required magnetic anisotropy of the rotor 204.

FIG. 2c shows, by way of example, geometries of the individual metal sheets of the rotor 204. The individual metal sheet structure of the rotor 204 shows flow webs (magnetic paths) 202 of different reluctance, which are distributed symmetrically within the rotor. Examples of individual metal sheets of the rotor 204 of a 4-pole machine are shown.

The two types of reluctance motor have different advantages and disadvantages, which is why they are used in suitable applications according to their properties and characteristics as disclosed in Schröder, Dierk. Elektrische antriebe-regelung von Antriebssystemen. Berlin, Heidelberg: Springer Berlin Heidelberg, 2009. The individual metal sheets of the rotor 204 according to FIG. 2c have special geometries formed from magnetically conductive webs 202 and weakly magnetically conductive air gaps 201 (flow barriers), which generate the necessary magnetic anisotropy and are able to guide the magnetic flow according to application-specific specifications.

To improve the rotor's properties, the metal-sheeted rotors of reluctance motors are also equipped with permanent magnets—primarily with ferrite magnets—in the flow barriers 201. However, this requires a complex manufacturing process.

A characteristic of types of all reluctance motor, however, is that, in a basic version, they have a rotor 204 which has neither permanent magnets nor windings nor a squirrel cage: The rotor consists of a magnetically soft material.

This means that it is not only the geometry of the rotor that determines the operating behaviour of the reluctance motor, but also the material for the rotor sheets.

The magnetically soft material for the packets of metal sheets in the rotors of reluctance electric motors is usually provided in the form of what are referred to as electrical metal sheets. These electrical metal sheets are usually manufactured using a complex method.

Solid rotors, which are made from blanks with material properties similar to those of electrical metal sheets, are less commonly used. These are more susceptible to losses because the eddy currents generated in the rotor are not dampened by insulation.

The main material for the rotors in reluctance motors is ferromagnetic electrical metal sheet (iron+alloy components). This material has domains that share a common preferred magnetic direction. These domains are called Weiss domains. Due to the random distribution of the domains, the material initially acts in a manner unmagnetized to the outside. The elementary magnets can be aligned by an external magnetic field. However, no sudden change in direction occurs; instead, a magnetization reversal zone forms, known as the Bloch wall. The Bloch wall shifts (distribution and rotation of the domains) depending on the external field. This shift depends on the material properties.

The material for electrical metal sheets should be easily magnetizable and exhibit low core losses. These properties are determined by the process used to manufacture the electrical metal sheet and the alloy components of the electrical metal sheet.

The starting material must be alloyed in such a way that the specific electrical resistance is as high as possible and the irreversible Bloch wall shifts can occur in as unhindered a manner as possible. The main alloy component of electrical metal sheets is therefore silicon. Silicon increases the specific electrical resistance and facilitates the rotational processes during domain twisting. However, silicon also negatively influences existing production methods for rotor sheet manufacturing through punching and/or laser cutting. These methods influence the original structure of the electrical metal sheets through induced mechanical stresses and structural changes, increasing the core losses and reducing the permeability.

This fact was already taken into account in DE 10 2020 130 988 A1. The “method for producing a layered arrangement from electrical metal sheet, subsequently produced layered arrangement, rotor or stator, and electric motor” presented therein refers to the manufacture of layered arrangements from metallic powder which, in a preferred embodiment, are provided with a high proportion of silicon (and aluminium), which is why an electrical strip with these alloy contents could not be manufactured by rolling. Furthermore, the cited document also points out that layers of metallic powder of this composition could only be manufactured using generative production processes.

The quantity and size of non-magnetic inclusions influence the Bloch wall movements and grain growth. To keep magnetization losses and hysteresis losses low, the electrical metal sheet would have to be freed of impurities even after raw material production, that is to say during the rotor or rotor sheet manufacturing process, and a structure as coarse-grained as possible would have to be generated through heat treatment.

In addition to the negative influence on the structure of rotor electrical metal sheets through punching and laser cutting, these methods also limit the achievable thicknesses of electrical metal sheets in the rotor. Due to the specific electrical resistance, these thicknesses should be as low as possible, which poses problems with current manufacturing processes.

Magnetohydrodynamics (MHD), a branch of magnetofluid dynamics, describes the interactions of flows of electrically conductive fluids—in industrial applications, particularly in the processing of liquid metals and the melting of alloys-in electromagnetic, static and/or dynamic alternating current fields (rotating and travelling fields). Examples of conventional industrial applications include crystal growth and edge layer refinement of metallic materials.

MHD technologies have long been used in metallurgy for stirring and pumping melts. An improvement in the properties of metal melts in a continuous casting mould, i.e. the removal of inclusions, bubbles and pores in a melt, is already applied, for example, in DE 25 28 931 C2 through the use of the MHD method.

European application EP 0 613 957 A1, for example, describes a method which could be integrated into the method according to the disclosure with regard to its metallurgical method steps.

The electromagnetic modification of materials by means of electromagnetic forces has long been practised in processes such as melting, solidification, crystallization, and deposition of metallic and inorganic-non-metallic materials in magnetic fields according to B. Halbedel et al.: Potentiale elektromagnetischer Kräfte zur Modifizierung von Glasschmelzen. 82nd Glass Technology Conference Hameln 2008.

The use of the MHD method in the industrial field to influence the flow behaviour of liquid metals is shown, for example, in DE 102 25 781 B4:

The flow (streaming) of a molten column during laser welding from a weld seam is influenced according to process requirements by the Lorentz force, which results from the interaction between the applied magnetic field and the liquid melt. The flow is primarily slowed down here.

One application of the MHD method in the field of additive production can be found in a print head according to WO 2007/038987. Here, the MHD method is used in the form of a pump to eject an electrically conductive liquid (metal). However, it is not combined with MHD stirring.

The methods in the documents US 2016/0307678 A1 and US 2019/0375003 A1 are also based on the use of magnetic fields to influence liquid metals in the printed area during additive printing and in print heads.

According to US 2016/0307678 A1, this is intended to generate a magnetic anisotropy within a layer in a controlled manner.

US 2019/0375003 A1 generally describes a 3D printing system in which time-varying and static magnetic fields are used in a print head to eject magnetic particle material in droplet form through a dispensing nozzle. The magnetic fields also surround the dispensing nozzle to influence the direction of the magnetic particle material.

In US 2021/0323070 A1, comparable magnetic field generators are used at the dispensing nozzle to atomize magnetic particle material in droplet form. Such a method step is not effective for the purpose of influencing the properties of the liquid metal by means of magnetic fields during cooling with regard to magnetic domains, the number of movable Bloch walls and structural defects (homogeneity).

In principle, the technology of additive production of rotors (and stators) from layered electrical metal sheets—in which the electrical metal sheets are not produced from prefabricated electrical metal sheet coils, but rather through additive production methods for metal parts—is well known. Various established techniques can be used as additive production methods for metal parts.

What is unknown is the supplementation and coupling of existing printing methods with magnetohydrodynamics (MHD) for the purpose of influencing the structure of the electrical metal sheet during the process, both in the liquid medium shortly before solidification during printing, and during the transition of a metallic melt from the liquid to the solid state and shortly thereafter.

The manufacture of reluctance machines by means of an additive method is known in principle from Gässel, D.: 3D-printed motors-manufacturing principle and limits. 2020. https:/www.reseachgate.net/puplication/343933657 and Rudolph, et al.: Vollständig 3D-gedruckte geschaltete Reluktanzmaschine in Klauenpolausführung. Elektrotechnik & Informationstechnik 2019 136/2.

In Gässel, D.: 3D-printed motors-manufacturing principle and limits. 2020. https:/www.reseachgate.net/puplication/343933657, the methods used to date for the additive manufacturing of motors are evaluated with regard to practical application.

According to Rudolph, et al.: Vollständig 3D-gedruckte geschaltete Reluktanzmaschine in Klauenpolausführung. Elektrotechnik & Informationstechnik 2019 136/2, ceramic and metallic materials are processed using a 3D multi-material printer, allowing all active parts of an electric motor to be printed. However, the additive production method is based on the processing of paste-based materials, with the rotor being constructed of ceramic material. The shaping takes place during the printing process, in which highly filled pastes of the target materials are extruded layer by layer through a fine nozzle. During a subsequent heat treatment, the binders are eliminated and the particles are fused into a solid body. The resulting porous structure is a disadvantage.

A method according to DE 10 2020 130 988 A1 is intended to improve the magnetic properties in the manufacture of motors (stators and rotors) using a layer method. It is proposed that the magnetically soft component be produced from a large number of superimposed metal sheets as sintered components. The structure of the electrical metal sheets as sintered metal sheets is intended to result in expanded structural possibilities; the typical “punching” process steps could be eliminated and the electrical metal sheets configured as sintered parts could be manufactured with smaller thicknesses.

The method is based on the application of a paste using a screen printing method. The electrical metal sheets are formed by sintering and then processed into a stack.

A similar method according to DE 10 2020 130 988 A1 is presented in EP 3 708 938 A1. One difference is that a sinterable starting material in powder and/or paste form is used, not just in one form, but by using at least two different, metal-containing, sinterable starting materials. The aim of this is to create different, specific layer properties within a layer.

In EP 3 715 018 A1, the aforementioned method is expanded by a method step which involves aligning ferromagnetic and antiferromagnetic particles in a predetermined direction.

EP 3 180 141 B1 presents a method for manufacturing magnetic bodies in which, in a further step, areas with different magnetic properties are produced by means of additive production. It is based on the long-standing knowledge that magnetization values depend on the grain size of the material. In EP 3 180 141 B1, this property is advantageously implemented by creating areas of different grain sizes during additive production.

In terms of methodology, this is achieved by producing first layers for the magnetic body to be produced in predetermined areas using powder-based additive production methods and with previously specified material powders, in order then to add second layers which differ in their specifications from the first layers. The formation of different layers by fusing in predetermined areas together with the generation of necessary insulation layers is technically necessary but not very feasible economically.

The disclosure is based on the object of developing the generic method so that the packets of metal sheets for rotors and/or stators for reluctance motors or rotors for reluctance motors can be produced in a technically simple manner with improved power factors.

This object is achieved by the method as claimed.

The method is based on the use of known additive production methods and the MHD method (MHD magnetohydrodynamics). Magnetohydrodynamics describes processes in which the flow of, for example, molten metals is deliberately influenced using electromagnetic fields.

With the manufacturing method according to the disclosure, the structure can be positively influenced with regard to application-specific properties at the operating point during additive manufacturing. The operating point is a fictitious point at the nozzle outlet of the print head which describes the programmed path of the nozzle during application of the material.

The material is influenced in the liquid phase on a mounting plate by an applied magnetic field of a stator/rotor during the transition from the liquid phase to the solid state so that the finished rotor/stator sheet has a direction of flow aligned with the imprinted field pattern and with high magnetic conductivity.

In the method with liquid metal at the print head outlet, the metal's properties regarding magnetic domains, number of movable Bloch walls and structural defects (homogeneity) are influenced by magnetic direct and alternating current fields during solidification according to a specifically specified magnetic flow path.

The magnetohydraulic influencing in the nozzle area serves to meter and smooth the metal ejection in the nozzle area (damping turbulence) in order to be able to create defined metallic print paths. The control and regulation functions within the material flow are implemented according to these requirements.

The complex method chain for producing iron-silicon materials for electrical metal sheets and rotors in reluctance motors, and thus the entire method chain for producing the rotors, is integrated into a machine system for additive production, the melt alloy serving as the starting material and the properties of the melt at the operating point of the additive method being influenced by magnetic fields.

This is possible because, unlike in conventional method chains, first the starting material for the electrical metal sheet coils is produced and then the electrical metal sheets for the rotors, instead only as much material needs to be provided for the necessary metallurgical processes as is used in the additive process to print a layer at the current operating point in a given unit of time.

It is characteristic of the method that the thickness ranges of the metal sheets correspond to the achievable layer thicknesses in additive production. Based on current web speeds for metal printing, the method can be based on an expected time-to-print volume of approximately 10 cm³/min. Such volumes can be made available to the printing process at the operating point in the required time frame using a known inductive method for producing a melt in a melting pot. The small melt volume per unit of time necessary can thus advantageously be provided in melting pots whose geometric dimensions can easily be integrated into a 3D printing machine.

However, the manufacturing method can also be used to produce solid rotor structures with improved magnetic properties. Since the manufacturing method enables the production of both solid and layered (laminated) rotors, the method is described below only for the more complex layered rotors.

The manufacturing method can also eliminate the problems of negative structural influencing and metal sheet thickness limitations.

Negative material properties, such as voids, material defects, non-magnetic inclusions, grain boundaries and crystal lattice effects (dislocations), which have previously occurred increasingly in the conventional production of electrical metal sheets for rotors in reluctance motor, are reduced and even avoided.

In the method, a predetermined magnetic direction of flow is achieved by using a controllable MHD method.

By printing with different metal alloys and the necessary control of the MHD method, different specific layer properties can be produced within a layer.

In principle, the method for reluctance motors is applicable in both internal and external rotor designs.

In the internal rotor design, where the moving part (rotor) is located inside, the magnetic field generation for influencing the material during the printing process takes place with an external magnetic field generator.

In the external rotor design, where the moving rotor is located outside, the magnetic field generation for influencing the material takes place with an internal magnetic field generator.

The method steps described below are identical for both arrangements of the magnetic field generators. The invention is explained in more detail using some of the embodiments shown in the drawings.

### BRIEF DESCRIPTION OF THE DRAWINGS

FIG. 1 shows a reluctance motor with pronounced poles. The figure shows a) magnetic field lines and b) a geometry of an electrical steel sheet.

FIG. 2 shows, by way of example, rotors of reluctance motors with flow barriers. The figure shows examples of reluctance motor rotors with flux barriers and magnetic field lines a) in the d-axis, b) in the q-axis, and c) variants of flux barriers per Neusüs, Sascha. “Vergleich von synchronen Reluktanzmotoren ohne und mit Ferritmagnetunterstützung.” (2021).

FIG. 3 shows a flow diagram of the method according to the disclosure.

FIG. 4 shows a detail of method step S8 of the method according to FIG. 3.

FIG. 5 shows a schematic representation of integrated machine units for implementing the method.

FIG. 5a shows a reduced height of the printing plate for variothermic heating.

FIG. 6 shows a schematic representation of a field pattern for generating a magnetic field to influence the melt during the printing process. Examples of field patterns include a) a pole count of 2 and b) a pole count of 3.

FIG. 7 shows, by way of example, geometries of individual metal sheets consisting of non-magnetic material for rotor geometries without air flow barriers. The material is a non-magnetic material, for example stainless steel.

FIG. 7a shows a section along the line A-A in FIG. 7.

FIG. 8 shows electrical metal sheet arrangements in the rotor.

FIG. 9 shows a schematic field pattern for magnetic field generation in an external rotor, in particular to influence the melt during the printing process. Example field patterns for an external rotor with 2 pole pairs.

### DETAILED DESCRIPTION

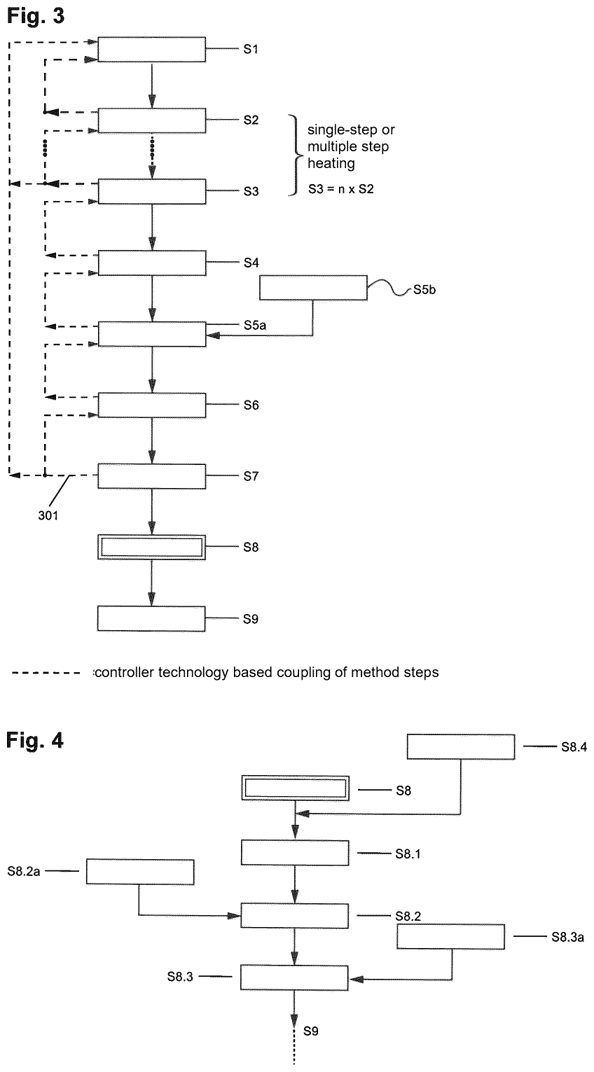

Using FIG. 3, the method sequence for producing the metal sheets is first explained in an overview.

In method step S1, the material is supplied as a semi-finished product, for example in the form of a metal alloy. The semi-finished product consists of materials that are prefabricated in terms of their shape and properties, whose alloy components are matched to the magnetic properties of the electrical metal sheet disc to be finished additively for a rotor. The feed takes place with at least one feed unit.

In method step S2, the semi-finished product is heated and melted using at least one inductor melting unit. The heating can be performed in one or more stages, preferably in a continuous method (method step S2 or S3).

In method step S4, the molten metal is transported using at least one magnetohydrodynamic (MHD) transportation unit.

In method step S5a, a homogeneous melt is generated, and the overall melt is stored, temperature controlled and MHD-stirred.

In method step S5b, alloy components can optionally be added to the molten metal as metal granules or bulk metal, or, for example, as recycled material.

In method step S6, the molten material is transported in a metered manner to at least one print head. For this purpose, at least one MHD transportation and melting unit is provided.

In method step S7, the melt is temperature controlled and dampened by a direct magnetic field. Movement is influenced in the longitudinal field. The melt is ejected from the print head in droplet form or continuously as a partial melt strand with the cross-sectional geometry of the print head nozzle. The print head for generating droplets and metal beads from a liquid metal alloy for the metal sheets can be configured as a module that can be coupled to a storage unit and equipped with at least one nozzle injector.

In method step S8, the melt and its solidification process are influenced by MHD during application of the material, for example, on a printing plate or mounting plate. In this case, a magnetization unit is advantageously used for MHD stirring and magnetic texturing during the production of the metal sheet.

The completion of the packet of metal sheets takes place in method step S9. A variothermal temperature control of the printing plate or the mounting platform for the metal sheet is performed.

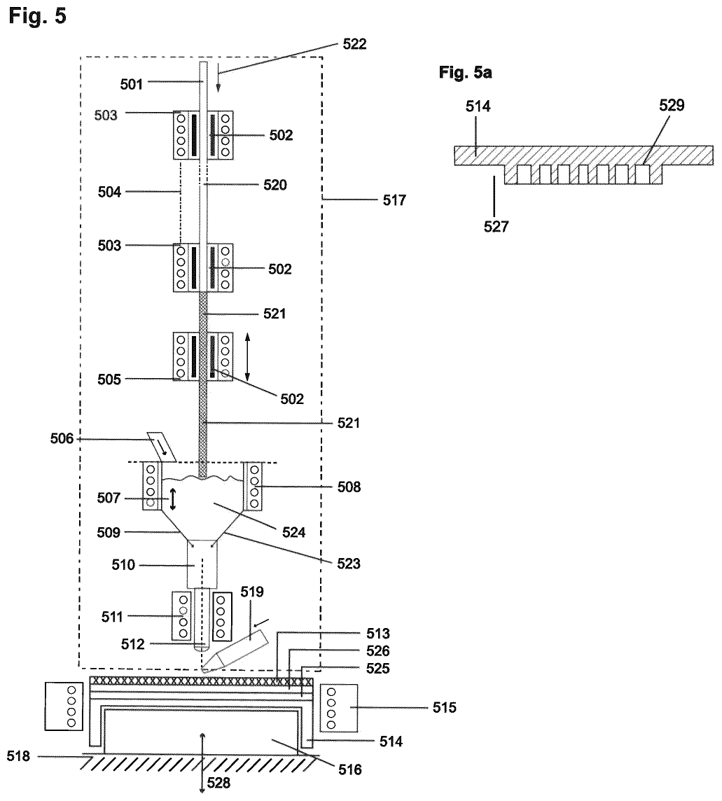

The individual machine units for the method steps can be constructed as a complete unit 517, as is shown in simplified form in FIG. 5, for example. However, due to the occurring and expected variable melt volumes, material alloys, process speeds during material application for electrical metal sheet generation, and the variation in the geometric dimensions of the electrical metal sheets (rotor diameter), it is advantageous for the method to implement the individual method steps of the method via a modular structuring of the overall system within a basic machine. In particular, modules which contain components that are prone to wear (melting pot materials) can thus be easily replaced.

For this purpose, the modules for the individual method steps S1 to S9 are advantageously provided with a uniform mechanical interface. Furthermore, each (thermally insulated) module has a communication interface, a sensor interface and an interface for the variable power supply of the inductors and MHD units.

FIG. 5 shows, by way of example, the complete unit 517 for producing rotor metal sheets for an internal rotor with the modules. One of these modules is an MHD unit 505, 508, 511. The MHD unit consists here of one or more coil arrangements surrounding a material carrier and/or storage device, and whose generatable magnetic field strength, frequency of the imprinted electric current, and amplitude are controllable and adjustable. These are shown by way of example and in a simplified representation in FIG. 5 for the implementation of different method steps (505, 508, and 511). The coil arrangements, which are not shown in detail, are implemented according to the necessary functions of the module within the method chain for specifying the desired flow behaviour for the liquid and/or semi-liquid metal.

All method modules are encapsulated so that the method steps within a module can be carried out under a suitable gas atmosphere and/or vacuum. The modular structuring of the machine units has no effect on process steps S1 to S9 for the method, so the module interfaces are not shown.

A control unit, which can be implemented as a central unit and is not shown in FIG. 5, controls the method modules—and thus the coil arrangements—to achieve a specified process goal, i.e. to achieve the desired properties of the printed electrical metal sheet based on sensor data and/or on parallel simulation results from a “digital twin” (process model). For this purpose, all modules are bidirectionally coupled to one another via control and communication technology 301. This coupling can be implemented using commercially available means and is therefore not described in detail.

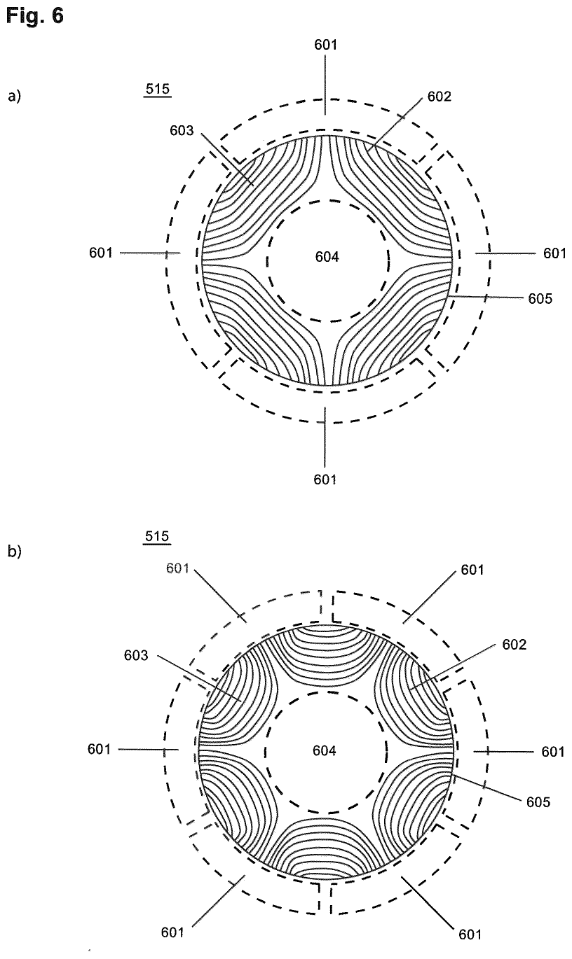

This particularly concerns the specification of the magnetic flow path as a result of a simulation of the magnetic flow path with a stator-like magnetization unit 515 (FIG. 5) for the path 602 in FIG. 6 of the print nozzle during printing of the electrical metal sheet. This method step is advantageous for optimal achievement of the desired process results, but it is not mandatory. The number and shape of the flow barriers, and thus the magnetic flow path, can therefore be specified via simulation and/or path programming.

With a modular structuring of the method, actuation can preferably be carried out via a module-integrated (thermally insulated) controller assigned to each method unit.

This is also advantageous if each module contains all process information from the other modules involved in the method. Each module is thus capable of making autonomous online decisions regarding process control. Only target geometries for the rotor electrical metal sheets, material properties, parameters for currents, voltages and frequencies for the magnetic field generation and temperatures are then specified centrally.

The flow diagrams according to FIG. 3 and FIG. 4 illustrate the sequence of the individual method steps within the overall method. The first method step S1 in FIG. 3—combined with a technical implementation as an interchangeable module that can be adapted to the process variants—is the material supply for the starting melt.

FIG. 5 shows an example of the system for implementing the method. The system is not limited to the system design described. Various embodiments of such a system are possible. The individual method steps S1-S9 in FIG. 3 and FIG. 4 are explained using FIG. 5. The system components are connected to one another by a control and communication coupling 301, which is shown only schematically.

A semi-finished product made of magnetically soft material 501 is fed to a melting pot system 504 (S1) using a controlled and regulated material feed 522 which can be designed as desired. It consists of at least one melting pot 502 made of a melt-adjusted material. The melting pot 502 is configured, for example, as an open pot. For heating and melting the semi-finished product 501, provision is made for at least one current-carrying inductor coil 503 which surrounds the melting pot 502. The melting pot 502 is configured as a susceptor. Since such susceptors are known, they will not be explained in detail.

Furthermore, the melting pot system is equipped with a coil cooling system (not shown) and surrounded by a gas atmosphere (not shown).

The semi-finished product 501 is heated as it passes through the melting pot system 504.

A modular structure of melting pot system 504 (current-carrying coil with melting pot made of melt-adjusted material, coil cooling and susceptors) for adapting the melting pot system to different materials to be melted is technically feasible and advantageous for the method since the size of a melting pot system 504 is small for additive production due to the small material quantities per unit time. If smaller quantities of semi-finished product 501 are to be melted per unit of time, the semi-finished product 501 can be heated and melted as it passes through the melting pot system 504—consisting of at least one melting pot 502 (method step S2—single-stage heating). For larger quantities of semi-finished product which cannot be heated and melted within a specified unit of time, the heating and melting take place in a two- or multi-stage method (method step S3). Two or more melting pots 502 are then provided. In the exemplary embodiment shown, the system for stepwise heating is equipped with two melting pots 502 lying one behind the other which form the melting pot system 504 and through which the semi-finished product 501 is passed.

The coils of the inductor system 503—not shown with specific features in FIG. 5—serve for transverse field and longitudinal field heating of the semi-finished product 501. The difference between the inductors for longitudinal field and transverse field heating lies in the respective electromagnetic field resulting from the arrangement and the associated heating behaviour. With longitudinal field heating, the magnetic field runs in the plane of the semi-finished product to be heated, which corresponds to a thin strip. The material is fully enclosed by the inductor. With transverse field heating, the inductors are mounted so that the electromagnetic field runs perpendicular to the plane of the semi-finished product to be heated. Transverse field heating is advantageous when using semi-finished products with the specified geometries. However, the coils are always arranged so that the field lines of the magnetic fields they generate have the desired direction according to their function. Longitudinal field generation (travelling field) is used for direction-influencing transportation of the melt and for temperature control.

The inductor coils for transverse and longitudinal field heating, as well as for stirring the melt in an intermediate storage unit 508, are adjusted to process-determining parameters, such as maximum required currents, frequency bandwidths and maximum required material flow rates, as well as to the requirements of a modular design, that is to say they are designed with a minimum number of turns in order to ensure a geometrically compact system structure within a machine system.

The intermediate storage unit 508 is equipped with at least one MHD stirring and transportation device and at least one temperature control unit.

Known materials such as graphite, silicon carbide and/or oxide ceramics can be used as materials for the melting pot 502—the geometry and material of which are generally adapted to the melting material to minimize the skin effect.

Heating, melting and, if necessary, superheating of the material 501 to be processed preferably take place via direct heating by inductive transverse field heating (S2 and S3), which offers advantages in terms of heating rate, particularly for materials with a small cross-section. As materials with a small cross-section, use can advantageously be made of magnetically soft materials in wire and/or strip form which are available on the market as semi-finished products with various cross-sections-for example as magnetically soft alloys with diameters of 0.2-5 mm.

Using speed-controlled feeders 522, which are by way of example and comparable to feeders of established FDM methods, these semi-finished products 501, which already consist of the desired alloy for the electrical metal sheet and/or can be further alloyed with additional materials in the intermediate storage unit 508, can, coupled in terms of control technology, be continuously fed online to the intermediate storage unit 508 at the required time intervals (S4). The melting pot 502 is advantageously designed here as an open pot—enclosed by the current-carrying coil—in a tubular shape (tubular susceptor), whereby heating above the Curie point can also take place via thermal conduction and/or thermal radiation.

The feed rate for the semi-finished product 501 in the form of a soft iron alloy as an actuator for controlled and/or regulated liquid metal processing in electrical metal sheet production is determined and specified as a parameter depending on the current strength and frequency of the current of the induction system 503—depending on the material and geometry of the semi-finished product 501.

By gradually heating and melting (S3) via tubular melting pots 502 connected in series, the melt volume per unit time can be increased in a frequency- and power-controlled manner. The negative influence of the skin effect, that is to say delayed, inhomogeneous heating of the material to melting, can thus be gradually reduced.

The subsequent method step (S4) for the method consists in the forwarding of the melt material and/or the partial melt 521 (partially liquid or liquid state) via a transportation module 505 into a melting pot 509 of the intermediate storage unit/provision area 508 for the print head 510. In contrast to the known printing methods, the melting does not take place in the print head, but rather upstream of it.

A specifically controlled and/or regulated further transportation can preferably be achieved via another melting pot system with longitudinal field heating 505. For this purpose, the electromagnetic field acts in the direction of and/or against the direction of gravity 507. The melt 521 can thus be actively controlled by a travelling field based on the same principle that is also used in linear direct drives, meaning the movement of the melt 521 can be accelerated and/or decelerated. Current strengths, frequencies and field directions can be set as required. It is advantageous if alternating current fields in direction, frequency and amplitude can be superimposed with direct current fields.

However, the melt 521 can also be forwarded by simply dripping it into a further, closed melting pot 509 of the intermediate storage unit/provision area 508. The intermediate storage unit/provision area 508 contains the method step (S5a) “Magnetohydrodynamic metal stirring (MHD)” and the maintenance of the required melt temperature for the printing process.

For this purpose, coil arrangements for influencing the flow of the melt 524 by means of magnetic fields are provided in the intermediate storage unit/provision area 508. The interactions between the induced magnetic fields and the liquid melt result in Lorentz forces, which cause the desired flows in the molten metal.

Coil arrangements and actuators can be used to implement different method functions (transporting, stirring, heating, etc.) using power actuators which can quickly (millisecond range) switch different, high-frequency and amplitude electrical currents in series, thus enabling a rapid, serial build-up of different magnetic fields (millisecond range), which can significantly reduce the cost of components. The coil arrangements for both the MHD stirring 508 and for generating a force 507 for transporting the melt depend on the structural embodiment of the intermediate storage unit and provision area 508 and are therefore not shown in detail in FIG. 5. The force 507 is the resulting force acting on the melt.

MHD stirring in the intermediate storage unit/provision area (508) performs the sub-process steps of thermal homogenization of the melt, mixing of the melt, pore reduction, uniform distribution of crystallization nuclei, removal of impurities and influencing of the cooling rate upstream of the print head (510).

Method step S5b enables the processing of additional materials alongside the processing of semi-finished products 501. For this purpose, further materials can be fed to the intermediate storage unit/provision area 508 via at least one feeder 506 in addition to and/or separately from S4. For example, this may be the admixing of additional alloy components or the admixing of recycled materials to the melt 524. These materials are preferably fed into the melting pot 523 in granular form to accelerate the melting process in the melting pot (reducing the influence of the skin effect).

The melting pot 523 is used in this way as an intermediate storage unit coupled to the print head 510.

For this purpose, method steps S5a and S5b are coupled in terms of control and regulation so that the process-influencing parameters, such as current strengths, magnetic field directions (stirring), transportation, etc., can be adjusted to the change in the quantity of melt 524. By homogenizing the melt, reducing pores, uniformly distributing the crystallization nuclei and influencing their number through the cooling behaviour of the melt from print head 510, the molten metal can be optimally adjusted to the requirements of an electrical metal sheet for a rotor disc.

In method step S6, the liquid metal is fed to the print head 510 by gravity at a time interval required for the printing process (liquid volume provision). However, the emptying of the intermediate storage unit/provision area 508 can also advantageously be influenced (accelerated/decelerated) by an electrodynamic transverse field 505 in the feed rate (compare with method step “transporting the melt S4”).

In a method step not described in further detail, droplet generation takes place for the additive production of the electrical metal sheet within known functions in print heads. Print heads 510, as described in DE 10 20022 101 340 A1 and WO2007038987 A1, use the MHD method as an electrodynamic pumping principle for droplet generation.

By adjusting a mechanical and electrical interface 509 (not described in detail) to the aforementioned method modules, these can be integrated into the method chain.

The subsequent method step S7 requires a change in the nozzle structure compared to current print heads. The coil arrangements 511 for generating magnetic fields are structured such that the melt volumes within the nozzle 512, as also in method step S5a, can be controlled via the generated magnetic fields, and the viscosity and nucleation can be controlled by influencing the temperature of the melt, homogenization can be carried out by MHD stirring, and the melt flow can be influenced (acceleration/deceleration) within the nozzle 512. For this purpose, the nozzle 512 is surrounded by the coil arrangements 511. Here, too, the coil arrangements, both for the MHD stirring 508 and for generating a force for transporting the melt and the melt droplets 507—comparable to the functional implementation within method step S5a—depend on the structural embodiment of the nozzle 512 and are therefore not shown in detail in FIG. 5.

To synchronize the stirring, transporting and temperature control, this method step is also coupled to the other method steps in terms of control and communication according to FIG. 3.

In addition, the electromagnetic field of the coil arrangement prevents premature cooling of the melt or the melt droplets compared to method step S5a. This is achieved by switching at least one coil as an inductor at the required time interval.

Furthermore, through targeted magnetohydrodynamic influencing of the metal drop steel emerging from nozzle 512, its turbulent components can be dampened via a direct magnetic field which has a positive effect on the material distribution at the operating point on the printing plate/mounting plate 514. The coil arrangements 511 are therefore to be controlled such that alternating magnetic fields and direct magnetic fields can be superimposed in amplitude and frequency.

To further influence the crystallization rate within method step S7, the print head nozzle 512 is equipped with at least one integrated additional nozzle 519 for temperature control of the printed material. However, the additional nozzle 519 can also be arranged externally to control the crystallization process by influencing the temperature.

To avoid influencing the magnetic field required in the subsequent method step S8, the magnetic field in the nozzle area should advantageously be magnetically insulated from the plane 513 of the additively manufactured workpiece.

By applying the melt 524 at the nozzle 512 onto the printing plate/mounting plate 514, a local melt pool (partial melt) is created as the partial geometry 204 of the workpiece, that is to say an electrical metal sheet disc for a rotor, as shown by way of example in FIG. 2. The relative movement between the nozzle 512 (TCP—Tool Centre Point) and the movement-executing part 518 of the machine for additive production results in the overall geometry of the rotor metal sheet via the movement control of the 3D printing machine. The sum of the cooled partial melts thus results in an individual disc made of a magnetically soft material for a metal-sheeted rotor with optimal, specific electrodynamic properties.

The sum of the partial movements for generating an individual rotor sheet can advantageously, but not necessarily, be broken down into partial movements, during which the melt pool is additionally influenced in a magnetohydrodynamic manner, and into an area subject to conventional material application.

An essential method step (S8) of the method is formed by influencing the droplet melt via magnetic fields during its path movement between the nozzle 512 in FIG. 5 and the movement-executing part 518 of the machine for additive production and during its solidification process on the printing plate/mounting plate 514 or during the printing of several superimposed layers, during their solidification on the preceding layers.

The preceding method steps S1 to S7 in FIG. 3 relate to an improved, machine-integrated, modularly structured material provision in the form of high-quality metal melts for the additive production of electrical metal sheets for rotors.

This material provision arrangement can generally also be used for other metallic materials to provide high-quality, application-specific melts for additive production.

Method step S8 in FIG. 3 is formed by six sub-process steps, which together result in the production of electrical metal sheets for reluctance motors with improved magnetic properties. In FIG. 4, method steps that determine production are additionally shown in a subdivision.

In order to be able to influence the melt during the solidification process via the magnetic field generation unit 515 according to FIG. 5, this unit must be adapted in a method step S8.1 in terms of its geometric design and in its magnetic field generation according to the motor type to be produced. The adjustment also affects the size of the geometric surface of the printing plate/mounting plate 514, adjusted to the size of an electrical metal sheet to be printed, for example according to 204 in FIG. 2.

The subsequent method step S8.2 includes the magnetic field generation 515 (FIG. 6) with a magnetic field generator 601 and thus the flow generation for influencing the melt at the operating point of the nozzle 512.

The method utilizes the property that, under certain conditions, molten metals can be cooled to temperatures below their melting point without solidifying into a solid.

Within this supercooling range between the Curie temperature and the solidification temperature and below the solidification temperature, the crystallization process of the current partial melt is influenced by the magnetic fields of the magnetic field generating device 515, whose geometric dimensions are adjusted to the geometry of the electrical metal sheet to be printed, by MHD stirring 601 of the melt at the operating point and by superimposed static and dynamic alternating current fields 601. The actuation can also be carried out in such a way that only static or only dynamic fields are generated to fulfil the desired function.

The influencing of the melt in method step S8.3 in FIG. 4 takes place in such a way that, for magnetic stirring and for generating a directed magnetic flow, a stator structure comparable to that of an asynchronous motor, shown in simplified form and by way of example as a magnetic field generator 601 in the top view 604 of the printed area in FIG. 6, is used to generate flow in the printed area of the electrical metal sheet to be generated. One difference, however, is that the number of pole pairs of the flow-generating magnetic field generator corresponds to the number of pole pairs of the electrical metal sheet to be printed. This is illustrated in FIG. 6 in which the generated flow path 602 is shown in an area 603 in which flow barriers can also be introduced, once for an electrical metal sheet of a motor with the pole pair number of 2 and once with a pole pair number of 3.

The magnetic field generator 601 is used for stirring, influencing the crystallization process, damping the melt, and the like.

For the method, the electromagnetic field can be controlled here by an alternating current field, adjustable in frequency and amplitude, required for the desired process result, and/or a superimposed direct current field, adjustable in amplitude, which corresponds to the desired direction of flow. Examples of this are the field line course 203 in FIG. 2 or field line course 602 in FIG. 6. This can be achieved by MHD stirring and/or by generating anisotropy. The magnetic field can be influenced in a controlled manner here between two adjacent poles or across all poles. The alternating current field component is specified between a predetermined pole pair number, and the direct current field component can preferably be applied across all poles of the magnetic field generator 601.

The fact that an adjusted, flow-generating magnetic field generator 601 must be used for the rotor printing for each motor geometry shows that the area of electrical metal sheet printing (S8.1 to S8.4) is also preferably implemented using modular technology.

It is advantageous, but not mandatory, for the method, if the melt is applied in droplet form or as a plastic strand in the direction of the magnetic flow 602, which is previously determined by simulating the flow path in the rotor sheet/stator sheet within method step S8.2a.

This procedure is particularly advantageous for the production of electrical metal sheets for reluctance motors with flow barriers 201 (FIG. 2) for optimal guidance of the flow in the rotor. Instead of homogeneous rotor sheets, the rotor of this type consists of metal sheets with specially shaped contours which specifically guide the magnetic flow (flow webs 202 or flow barriers 201). The specially structured flow webs of the poles (d-axis) and the flow barriers (of air) in the gaps (q-axis) are important for advantageous motor operation. Through the flow guidance 602 according to FIG. 6 during the additive production of such rotor sheets using the method, a significant improvement in the motor properties is to be expected.

The ultimate goal of method steps S8.2 to S8.3a is to optimize the hysteresis shape in the printed electrical metal sheet in an application-specific manner. To this end, firstly, the obstruction of Bloch wall movements in the magnetically soft material must be eliminated or at least significantly reduced by the method by eliminating or at least reducing the defects in the material through magnetic field influence by means of HID stirring 515, and, secondly, electromagnetic anisotropy must be induced.

These method steps result in a refinement of the magnetic domains-which corresponds to an increase in the number of movable Bloch walls-and leads to a reduction in overall losses when using the electrical metal sheets produced in this way for the rotor of the reluctance motor.

The alternating component of the electromagnetic field causes here a homogenization of the melt with regard to its alloy components, a thermal homogenization of the melt in the current printed area, an influence on crystallization at the current operating point of the print nozzle 512 and the print head 510, and thus also the magnitude of the degree of supercooling (see also grain size influence in connection with variothermic heating), a reduction of unwanted inclusions as defects in the metal structure, and a reduction of pores by eliminating dissolved gases in the current melt pool (reduction of cavities and segregations).

The imprinted direct current field leads to a type of anisotropy (texture) characterized by imprinting a crystal orientation in the direction of flow of the subsequent application, that is to say in the direction of flow of the field lines 203 (FIG. 2) when energizing a reluctance motor in the rotor. It is expected that in the imprinted direction of flow 602 (FIG. 6), higher magnetizability and lower magnetization losses for the electrical metal sheet will result, this being reflected in an advantageous, application-specific course of the hysteresis curve. Furthermore, the direct current field calms the melt at the operating point, which has a positive effect on the surface roughness of the printed electrical metal sheet.

The amplitude of the direct current field is significantly greater here than that of the high-frequency alternating current component; the specification of the required respective values depends on the material volume to be processed per unit of time, the material alloy, the current temperature-dependent material state (degree of crystallization), and the required cooling rates.

The setpoints for actuating the stator 515 generating a magnetic field can preferably be derived from a simulation of a digital twin as a result of a simulative determination of the solidification structure, from which the path generation for printing the electrical metal sheet along the flow lines can also be derived (S8.2a). The ratio of process time constants for the application of the liquid melt to the computing time required for real-time determination of the setpoints enables this approach. However, experimentally determined parameters can also be used to adjust field strengths, alternating current field frequencies and direct current field components for the MHD process.

The cooling rate determines the grain growth of the solidifying melt. Influencing towards larger grain sizes is preferably desired.

This can result in an additional increase in permeability. For this purpose, the integrated cooling and heating options in the nozzle 512, the additional nozzles 519 and/or a temperature control unit 516 of the printing and mounting plate 514 are supplied with the necessary control variables. The temperature of the printing/mounting plate 514 can easily be adjusted using the temperature control unit 516. The device configuration options for the heating/cooling functions are diverse; they are therefore only shown schematically by way of example in FIG. 5. The structural state after printing determines the application of the respective cooling and heating options.

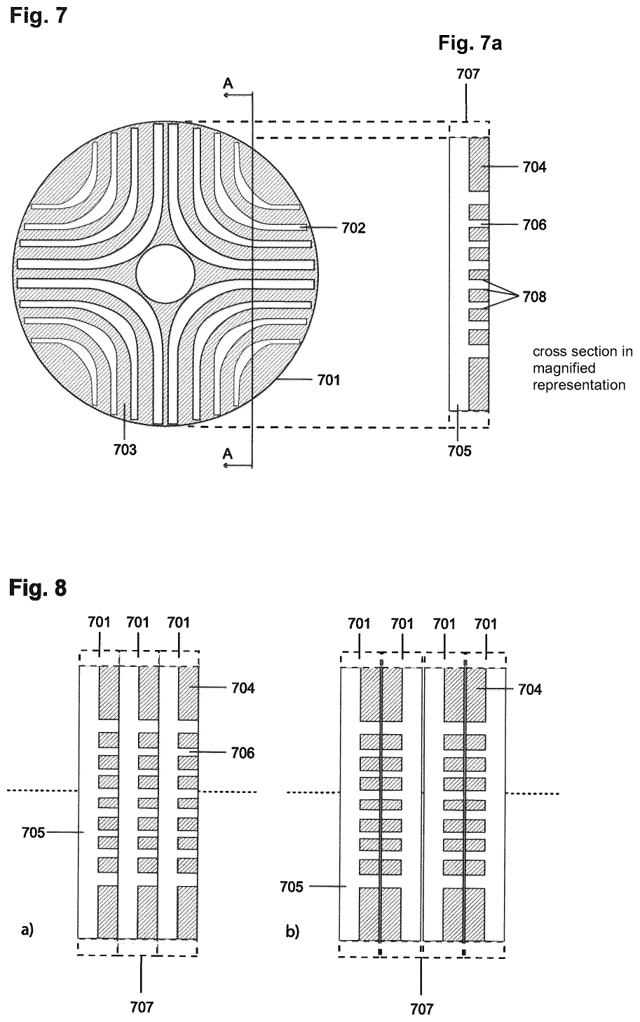

In order to advantageously influence the melt—in particular at the current operating point—a process-adapted structure is required—deviating from the design of the printing plate/mounting plate according to the prior art—so that the previously mentioned method steps can be implemented. Basically, the printing plate/mounting plate 514—just like the adaptation of the magnetic field generator/stator 515—must be adapted to the desired geometry of the electrical metal sheet 701 (FIG. 7) for the rotor.

To prevent the melt from contacting the printing plate/mounting plate 514 during printing, it must be provided with temperature-dependent, electrically conductive, commercially available high-temperature ceramic coatings 526. These coating methods are known and will therefore not be discussed further.

The addition of a susceptor layer (e.g. graphite) 525 enables the implementation of MHD stirring and the influencing of the melt in the supercooled area. The mode of operation thus corresponds to that of MHD stirring via alternating magnetic fields in an open melting pot (S8.2). The high magnetic resistances (air) between the poles of the stator, as a magnetic field generator, are thus eliminated.

The temperature range of the melt and its cooling rate determine, inter alia, its supercooling range, which is important for the duration of any magnetohydrodynamic influence.

In a further method step (S8.3a), in addition to the thermal and magnetic influencing in the supercooled area, the cooling behaviour of the printing plate with the partial melt and the already partially solidified printed areas is influenced in a controlled manner with regard to the cooling rate by means of the temperature control unit 516 (FIG. 5) in order to delay premature edge zone solidification and influence the structure formation. Since the electrical metal sheets to be produced have a low thickness (e.g. 0.2 mm-1.0 mm), temperature control based on variothermic heating is feasible.

Variothermic heating is understood to be a dynamic, local increase in the temperature of components by means of component-integrated heat sources to influence viscosity, primarily in thin-walled channels. Laser-integrated inductors for alternating current field generation etc. are often used as heat sources. This represents a well-known technology and will therefore not be discussed further.

For this purpose, the printing plate/mounting plate 514, as shown in FIG. 5a, is preferably geometrically structured in the direction of the imprinted direction of flow 602 (course of the webs of the electrical metal sheet to be generated) between the poles of the magnetic field generator 601 so that a minimum of printing plate/mounting plate material needs to be thermally influenced (low thickness of the printing plate/mounting plate). However, the entire area of the flow barriers 603 can also be designed as an extremely thin disc. A high, process-dependent temperature control rate can thus be achieved. Since there is no time-critical process influence, the areas of the solidified melt can be temperature-controlled via inductive heating. The printing plate in FIG. 5a thus forms a geometrical mirror image 527 of the course of the printed soft iron alloy to the flow guide 603 of the rotor sheet 701 to be printed, as shown by way of example in FIG. 7, and is to be adapted to its respective final geometry.

However, the printing plate/mounting plate 514 can also consist of a non-magnetic material, the latter then being provided with a susceptor layer on the surface facing the printing nozzle in a previous method step. This layer maps the course of the desired magnetic flow of the electrical metal sheet to be printed. This makes it possible to specifically control the temperature of the printing plate/mounting plate 514 using induction to influence the crystallization process.

The further method steps (S9) consist of coating the printed metal sheets with an insulation layer in a subsequent additive process using a print head operating in parallel, removing the additively manufactured rotor sheet from the printing plate (mounting plate), and packaging the electrical metal sheets (metal sheet stack) to form the rotor.

If multiple layers are printed on top of one another, the position of the printing plate/mounting plate 514 is then first lowered (528) via the movement-executing part 518 of the machine in FIG. 5. In this way, the magnetic field generation always acts in the printing plane 513. This process step is repeated until the rotor is completed.

Rotor sheets with different materials (e.g. different electrical conductivities) can also be printed within the same metal sheet. For this purpose, two printing devices print using the same method 517, but different semi-finished products 501, in parallel, exchanging the current geometries for path generation in the control system according to 301 and filling the areas to be printed 603 with the respective material.

If individual metal sheets are to be coated with insulation layers, then this can be done after printing the rotor sheets in conventional additive manufacturing machines-which are not listed here.

A further, complementary method chain (S8.4) is provided by placing onto the printing plate/mounting plate 514 an imprinted support material 705 which, due to its geometric structure, has the ability to absorb the magnetically active soft iron 704 through the additive printing method (FIG. 7). The outer contour 707 of the support material 705 corresponds to the outline of the finished individual metal sheet. On one side of the disc-shaped support 705, a structure in the form of depressions 708 is introduced by an imprinting process into which the soft iron alloy 704 is introduced to form the flow guidance 703. The depressions 708 thus have a course corresponding to the guidance of the flow 703 of the finished individual metal sheet (FIG. 7). As can be seen from FIG. 7a, the depressions 708 are advantageously of the same depth and are fully filled with the soft iron alloy 704.

The support 705 consists of a non-magnetic material, e.g. stainless steel. Due to the structure described, the individual metal sheet has no air flow barriers. The webs 706 of the support 705 which delimit the depressions 708 form the flow barriers 706. This shaped metal sheet is placed between the printing plate/mounting plate 514 and the nozzle 512 for each print of an individual electrical metal sheet. The result after printing is shown in the top view 701. The method chain presented so far is retained.

The extension takes place in the course of method step S7 and before the execution of method step S8. The support material 705 is made of non-magnetic material by mass-deepening imprinting and, together with the magnetic flow areas 704 supplemented by additive printing, corresponds to an individual electrical metal sheet for a rotor 707. The flow-blocking and flow-guiding areas 702 and 703 are produced by mass-deepening imprinting. An advantage of this method for producing an electrical metal sheet is that no insulating coating is required between the individual rotor sheets, and losses in the rotor metal sheet stack are reduced. Furthermore, the structure created by imprinting can easily absorb the mechanical stresses on the electrical metal sheets.

A further possibility for producing the electrical metal sheets according to the extended method chain consists in replacing the printing with a soft iron alloy for flow guidance with printing with commercially available ferrite pastes for flow guidance. The essential partial method steps S8.1 to S8.3 in the method chain S8 according to FIG. 4 remain unchanged. The print head 510 is replaced with a suitable print head for this material, as is the provision of material for it.

Suitable print heads for this purpose are available on the market. Their function is such that the pasty material fed in via the extruder is also forwarded within the print head via an extruder assembly to the nozzle of the print head, where it is ejected. Print heads for the 3D printing of concrete are examples of this. For the present method, this means that the pasty material, instead of the liquid metal, is transported via an extruder to the intermediate storage unit 523 and applied to the printing plate/mounting plate via the exchanged extruder print head and the print head nozzle.

By implementing the method as a modular structure, a method extension of this type is technically simple to implement.

In FIGS. 7 and 8, the cross-sections of the support structure are shown enlarged for better understanding. The imprinting depth determines the thickness of the flow-guiding layer 704; it essentially corresponds to the desired or required thickness of a conventional electrical metal sheet (thickness ranges between 0.1 and 2 mm, for example). The remaining layer thickness of the support 705 can be reduced to a minimum (fractions of a mm), since the imprinting process has a stiffening effect on the support. This continues to ensure that the temperature control unit 516 influences the cooling process of the melt during printing by means of variothermic heating.

FIG. 8 shows, by way of example, two possible arrangements of electrical metal sheets for forming a rotor according to the method. The packet of metal sheets is formed by the superimposed individual metal sheets 701 according to FIG. 7. It has the flow barriers 702 and the flow guidance 703.

In the embodiment according to FIG. 8a, the individual metal sheets 701 are stacked in the same direction to form a metal sheet stack.

FIG. 8b shows the possibility of stacking adjacent individual metal sheets 701 on top of each other, rotated by 180°.

The method was described above in connection with an internal rotor. However, designs in which the moving part—the rotor—is external are also encountered. However, these designs share identical functional structural features for the rotor sheets.

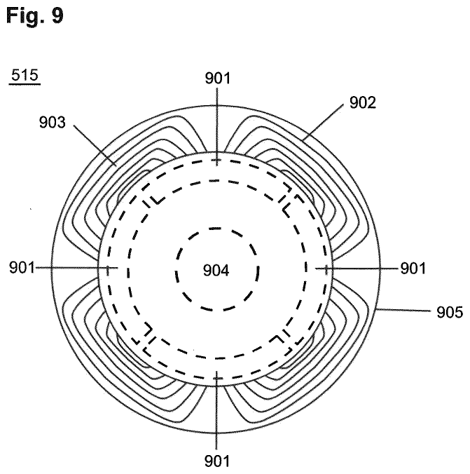

FIG. 9 shows, by way of example, an external rotor in which the rotor surrounds the stator. The external rotor has, by way of example, a pole pair number of 2.

FIG. 9 shows the schematic field pattern for the magnetic field generation used to influence the melt during the printing process.

Production takes place with the complete unit 517 (FIG. 5), the magnetic field being generated by means of a stator-like structure, adjusted to the geometry of the electrical metal sheets to be printed, for influencing the material during the printing process.

FIG. 9 shows the internal magnetic field generators 901, with which a stirring process, influencing the crystallization process, damping of the melt, etc. takes place, as described above using the exemplary embodiment for an internal rotor.

902 represents a magnetic flow field pattern generated by way of example by a simulation. The course 902 advantageously corresponds to the path of the print head nozzle (TCP=Tool Centre Point).

903 shows the area of the already described flow barriers. 904 denotes the top view of the printed area. The printing plate/mounting plate (see FIG. 5) has the contour 905 which corresponds to the outer contour of the described ceramic coating and any susceptor layer present.

### REFERENCE NUMERALS

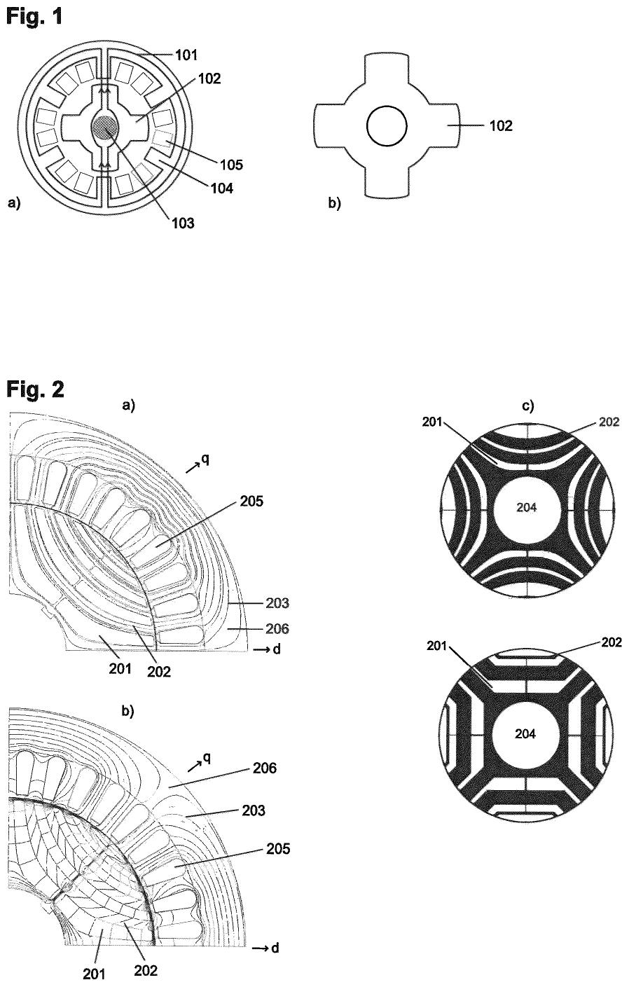

### FIG. 1:

101 Field line course
102 Pronounced poles of the electrical metal sheet
103 Rotor
104 Stator poles
105 Excitation coils

### FIG. 2:

201 Barriers to flow in the rotor sheet; different, property-determining geometrical courses
202 Flow webs
203 Field line course
204 Electrical sheet geometry of a reluctance motor with flow barriers
205 Stator winding
206 Stator sheet

### FIG. 3:

S1: Material supply as a semi-finished product (metal alloy)
S2: Heat and melt metal alloy (semi-finished product); single-stage
S3: Heat and melt metal alloy (semi-finished product); multi-stage
S4: Transport melt
S5a: Generate homogeneous melt, store overall melt, control temperature and carry out MHD stirring
S5b: Supply supplementary alloy components as granulate and bulk
S6: Transport the melt in a metered manner into the print head
S7: Temperature control and damping of the melt using a direct current magnetic field; influencing movement in the longitudinal field and ejecting the melt in droplet form or continuously as a partial melt strand from the print head with the cross-sectional geometry of the print head nozzle.
S8: Magnetohydrodynamic influencing of the melt and its solidification process during material application on the printing plate/mounting plate.
S9: Method steps for completing the rotor according to the prior art
301 Control and communication technology coupling

### FIG. 4:

S8.1 Adjustment of the magnetic field generator (stator) and of the printing plate/mounting plate to the geometry of the electrical metal sheet
S8.2 Magnetic field generation in the magnetic field generator and flow generating to influence the melt at the operating point of the nozzle
S8.2a Calculation of the magnetic field parameters and the required flow path using the simulative methods and experimentally determined parameters
S8.3 Control of induced magnetic fields as a function of the path speed, the material application volume and the solidification state of the melt.
S8.3a Control of the cooling rate (crystallization) by means of variothermic heating.
S8.4 Methodological extension of method steps S1-S8.

### FIG. 5:

501 Soft magnetic semi-finished product, supplied via a controlled and regulated material feed
502 Melting pot, shown in the example as an open pot
503 Induction system for heating and melting the semi-finished product
504 Multiple melting pots arranged in series for gradual heating
505 Longitudinal field generation (travelling field) for direction-influencing melt transportation and for temperature control
506 Supply of additional alloy components and recycled materials (granules)
507 Resulting direction of force on the melt
508 Intermediate storage unit with MHD stirring and transportation device and temperature control
509 Coupling of the melting pot in the intermediate storage unit to a print head
510 Print head
511 Coils with magnetic field generation arranged around the nozzle for MHD influencing of the melt in the nozzle area
512 Print head nozzle with integrated cooling and heating options for the printed material to influence crystal growth
513 Level of the additively manufactured electrical metal sheet
514 Printing plate/mounting plate, in the area of imprinted the flow lines extremely thin construction for variothermal temperature control
515 Magnetic field generation by means of a stator-like structure-adapted to the geometry of the electrical metal sheet to be printed-for influencing the material during the printing process.
516 Temperature control unit
517 Schematic representation of the process components in the machine
518 Movement-executing part of the machine for additive manufacturing
519 Additional nozzles for supplementary control of the crystallization rate by influencing the temperature
520 Heated semi-finished product
521 Partially liquid and liquid state of the soft iron alloy
522 Feed unit
523 Melting pot as intermediate storage unit, coupled with the print head
524 Metal melt
525 Susceptor layer
526 High-temperature ceramic coating
527 Geometric course as in 703
528 Lowering direction by metal sheet thickness when printing solid rotors
529 Reduced height of the printing plate/mounting plate according to the imprinted flow path for variothermal heating

### FIG. 6:

515 Magnetic field generation by means of a stator-like structure—adapted to the geometry of the electrical metal sheet to be printed for influencing the material during the printing process.
601 Magnetic field generators (stirring, influencing the crystallization process, damping the melt, etc.)
602 Example of a magnetic flow field pattern generated by simulation=path of the print head nozzle (TCP tool centre point)
603 Area of the flow barriers
604 Top view of the printed area
605 Contour of the printing plate/mounting plate; corresponds to the outer contour of the ceramic coating and the susceptor layer

### FIG. 7:

701 Geometry of an individual metal sheet
702 Imprinted flow barrier course made of non-magnetic material
703 Printed soft iron alloy course for flow guidance
704 Soft iron alloy
705 Imprinted support material
706 Remaining structure geometry as a flow barrier
707 Outer contour (diameter) of the electrical metal sheet
708 Imprinted structure in the form of depressions
FIG. 8: Options for the arrangement of electrical metal sheets

### FIG. 9:

515 Magnetic field generation by means of a stator-like structure-adapted to the geometry of the electrical metal sheet to be printed for influencing the material during the printing process for an external rotor
901 Magnetic field generators (stirring, influencing the crystallization process, damping the melt, etc.)
902 Example of a magnetic flow field pattern generated by simulation=path of the print head nozzle (TCP—Tool Centre Point)
903 Area of the flow barriers
904 Top view of the printed area
905 Contour of the printing plate/mounting plate; corresponds to the outer contour of the ceramic coating and the susceptor layer.

1.-23. (canceled)

24. A method of additively producing metal sheets, suitable for use in rotor and stator sheet packets of reluctance machines, the sheets being made of magnetically soft materials, the method comprising:
feeding melted material to a print head;
depositing the melted material onto a mounting plate to form a rotor/stator sheet, thereby creating printed areas with different magnetic properties; and
applying a magnetic field to the melted material as it transitions from a liquid phase to a solid phase, such that the rotor/stator sheet exhibits a higher magnetic conductivity in a direction aligned with an imprinted field pattern than in other directions.

25. The method according to claim 24,
wherein, at a current operating point where a layer is generated, the melted material is influenced to be guided in a direction of flow by a magnetic field which is built up around the rotor sheet to be printed,
wherein the magnetic field is generated to influence a droplet melt in a magnetohydrodynamic manner during crystallization by way of a stator-like field structure in the printing plane.

26. The method according to claim 24,
wherein the magnetic field surrounds the electrical metal sheet to be printed for a rotor.

27. The method according to claim 24,
wherein the number of poles used for generating the magnetic flow in the printing plane is the same as the number of poles of the rotor to be finished, and
wherein the geometric sizes of the stator generating the magnetic field are advantageously adjusted to the desired size of the rotor.

28. The method according to claim 24,
wherein, above the Curie temperature of the melt, at the current operating point, the magnetic field acts as a controllable alternating magnetic field, wherein, below the Curie temperature of the melt, at the current operating point, the magnetic field acts as a controllable static magnetic field.

29. The method according to claim 24,
wherein the imprinted magnetic field constitutes an overlaying of direct and alternating current fields, wherein the static electric magnetic fields and the alternating electric fields can be actuated separately.

30. The method according to claim 24,
wherein adjacent poles of the stator generating a magnetic field are actuated to generate flow, wherein all of the poles of the stator generating a magnetic field are actuated to generate flow.

31. The method according to claim 24,
wherein a printing plate/mounting plate is subject to a variothermal temperature control,
wherein, for this purpose, the printing plate/mounting plate constitutes a geometric image of the flow path imprinted using a magnetic field, that is to say that the surface thereof opposite the printed side has contours which reflect the flow path imprinted.

32. The method according to claim 24,
wherein the temperature control within the depressions follows the course of the imprinted flow.

33. The method according to claim 24,
wherein the printing plates/mounting plates for printing the electrical metal sheets are adjusted to the geometrical sizes of the rotors or stators to be produced,
wherein, in the direction of material application, the printing plates/mounting plates are printed with a susceptor layer which eliminates magnetic resistance in the course of the imprinted magnetic flow.

34. The method according to claim 24,
wherein, to avoid any connection between printed material and printing plate/mounting plate, the latter is provided with a high-temperature ceramic coating, wherein the printing plate/mounting plate consists of a susceptor material.

35. The method according to claim 24,
wherein a support is inserted on the printing plate/mounting plate to receive the flow-guiding material.

36. The method according to claim 24,
wherein the flow guidance has been determined simulatively by means of a digital twin.

37. The method according to claim 24,
wherein the course of the flow barriers is produced by mass-deepening imprinting.

38. The method according to claim 35,
wherein a geometry of the support is carried out.

39. The method according to claim 24,
wherein the individual method steps for producing electrical metal sheets for three-phase drives, in particular for reluctance machines, constitute parts of an overall method and are fully integrated into a machine system for additive production which is advantageously of modular construction.

40. The method according to claim 24,
wherein at least one melting pot with a liquid metal alloy for soft iron production is functionally integrated into the machine system,
wherein an application-specific alloy is provided for the electric motor by means of magnetohydrodynamic stirring.

41. The method according to claim 24,
wherein the pore- and bubble-free liquid metal alloy treated using the MHD method is pumped on to at least one print head by means of MHD methods, the latter advantageously being configured as a pump according to the MHD principle and forming a unit with the electromagnetic stirring of the melting pot.

42. The method according to claim 24,
wherein the rotor or the stator of a reluctance motor is printed by means of a liquid metal alloy according to its application-specific requirements layer by layer from homogeneous material as a solid rotor or stator or out of materials with different magnetic conductivities as a solid rotor or stator.

43. The method according to claim 24,
wherein the rotor or stator of a reluctance motor is printed by means of a liquid metal alloy according to its application-specific requirements layer by layer out of mutually electrically insulating layers or out of materials with different magnetic conductivities and mutually electrically insulating layers, wherein the insulation layer is applied using a second, alternating or parallel working print head.

44. The method according to claim 24,
wherein the poles of the stator are actuated according to a previously simulated flow path.

45. The method according to claim 24,
wherein, after each printed layer, a heat treatment is carried out by means of one or more print heads.

46. The method according to claim 24,
wherein the influencing of the melt at the operating point takes place under a protective atmosphere.
